(19) United States
(12) Patent Application Publication
(10) Pub. No.: US 2010/0317253 A1
(43) Pub. Date: Dec. 16, 2010

(54) Rotating Structure capable of Revolution and Rotation

(75) Inventor: Ming-Tay HSU, Chung-Li (TW)

Correspondence Address: HDLS IPR Services, PO Box 220746, Chantilly, VA, 20153, US

(73) Assignee: FOLUCK INTERNATIONAL CO., LTD.

(21) Appl. No.: 12/636,267

(22) Filed: Dec. 11, 2009

(30) Foreign Application Priority Data
Jun. 16, 2009 (TW) 098210710

(51) Int. Cl. A63H 11/00; F16H 1/02

(52) U.S. Cl. 446/236; 74/413

(57) ABSTRACT

A rotating structure capable of revolution and rotation includes a base, a gear device mounted on the base, and an ornament coupled to a rotation shaft of the gear device. The present invention uses the gear device to turn the ornament. The gear device has another rotation shaft fixed to the base. When an external force is applied to turn the gear device, the gear device will generate power for the ornament to rotate itself and to move around, providing a dual effect of rotation and revolution. By the difference between the two rotational speeds, the present invention provides a novel vision effect.

### BACKGROUND OF THE INVENTION

1. Field of the Invention

The present invention relates to a rotating structure capable of revolution and rotation, and more particularly to one using a gear device to turn an ornament, providing a dual rotation vision effect.

2. Description of the Prior Art

When a novel product is sold on the market for a period of time, consumers will lose their interests in the product. Therefore, producers have to create new products for attracting consumers to buy their products.

A conventional gear device is provided in a toy car or a toy puppet for the user to turn one rotation shaft of the gear device, and another rotation shaft of the gear device outputs power to move the toy car or the hands and feet of the puppet. Accordingly, the inventor of the present invention has devoted himself based on his many years of practical experiences to provide a novel rotating structure capable of revolution and rotation by using a conventional gear device, providing a moving vision effect for stationery, toys, gift articles or the like.

### SUMMARY OF THE INVENTION

The primary object of the present invention is to provide a novel rotating structure for an ornament to rotate itself and to move around, providing a dual rotation vision effect.

According to the present invention, there is provided a rotating structure capable of revolution and rotation, comprising a base in a fixed state; a gear device comprising a first rotation shaft and a second rotation shaft, the first rotation shaft being fixed to the base; and an ornament coupled to the second rotation shaft.

The present invention uses the base to fix the first rotation shaft of the gear device. When the gear device is turned and then releases power, the gear device will move with respect to the fixed first rotation shaft. This movement is defined as revolution. When the gear device releases power, the second rotation shaft will rotate itself to drive the ornament on the second rotation shaft to rotate as well, which is defined as rotation.

Because of the gear ratio of the gear device, the speed of revolution is less than the speed of rotation. By the difference between the two rotational speeds, the present invention provides a novel vision effect.

### BRIEF DESCRIPTION OF THE DRAWINGS

FIG. 1 is an exploded view of the present invention;

FIG. 2 is a schematic view showing a partial operation of the present invention; and

FIG. 3 is a schematic view showing an entire operation of the present invention.

### DETAILED DESCRIPTION OF THE PREFERRED EMBODIMENTS

Embodiments of the present invention will now be described, by way of example only, with reference to the accompanying drawings.

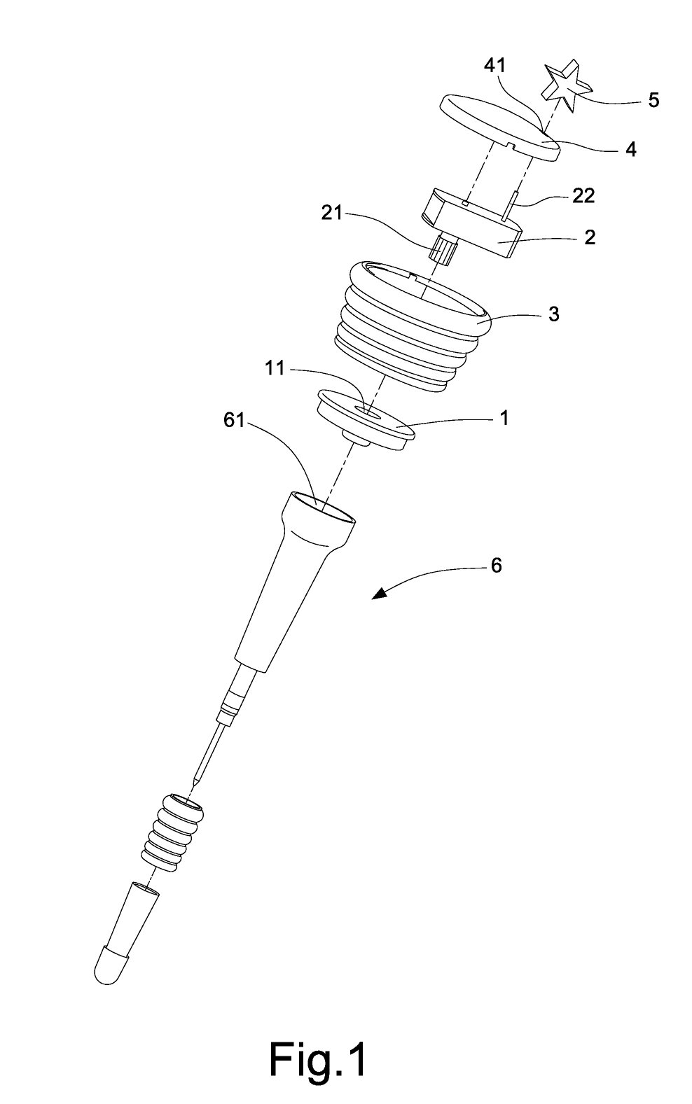

As shown in FIG. 1, a rotating structure capable of revolution and rotation according to a preferred embodiment of the present invention comprises a base 1, a gear device 2, a housing 3, a lid 4, an ornament 5, and an attachment 6.

The base 1 has a retaining trough 11 at a central portion thereof.

The gear device 2 includes a first rotation shaft 21 and a second rotation shaft 22 on two opposite surfaces thereof. The first rotation shaft 21 and the second rotation shaft 22 are located at an identical axis of the gear device. The first rotation shaft 21 is fixed in the retaining trough 11 of the base 1.

The housing 3 is hollow to accommodate the gear device 2 therein. The housing 3 is fitted on the base 1.

The lid 4 is disposed on the housing 3 and has a through hole 41 for the second rotation shaft 22 to extend therefrom. The through hole 41 is disposed close to an edge of the lid 4.

The ornament 5 is coupled on top of the second rotation shaft 22, which can be a natural object, a puppet or the like.

The attachment 6 can be a pen, a writing tool or any object. The attachment 6 has a chamber 61 for coupling with the base 1.

As shown in FIG. 1, the first rotation shaft 21 is located at the central axis of the housing 3. The second rotation shaft 22 is not located at the central axis of the lid 4, which is at an eccentric portion of the lid 4.

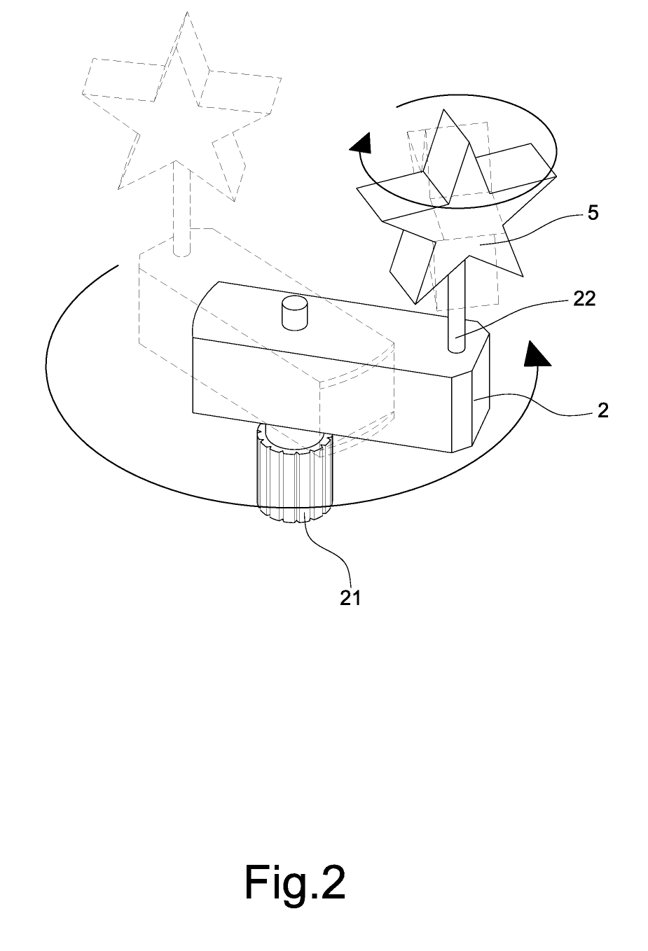

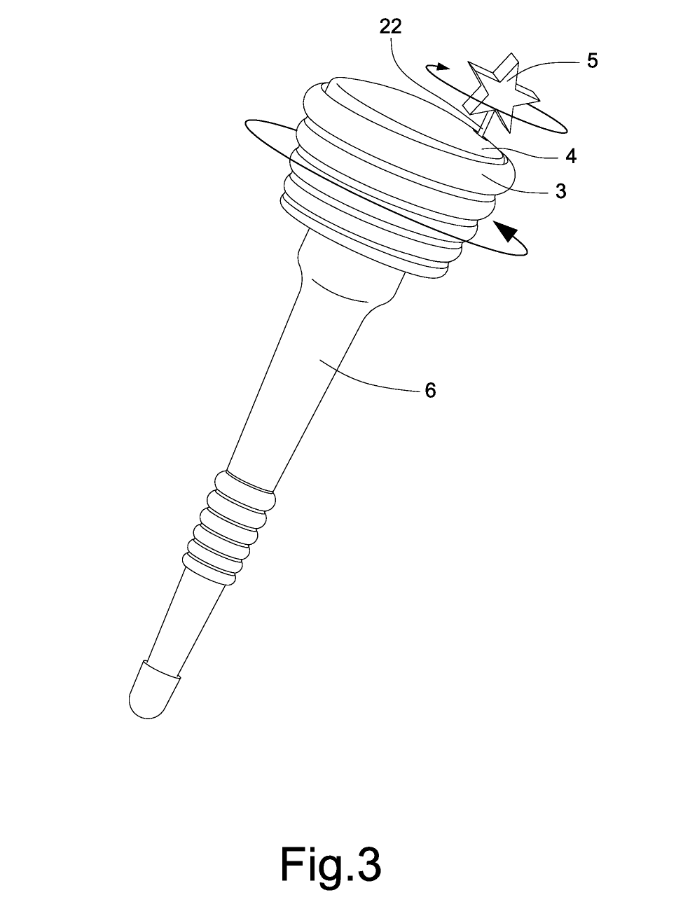

To operate the present invention, the user holds the attachment 6 with one hand and turns the housing 3 with another hand. Because the first rotation shaft 21 is fixed to the base 1, the base 1 is not rotatable. When the housing 3 is turned, the gear device 2 is linked to gear. After releasing the hand which turns the housing 3, the gear device 2 releases power to move the gear device 2 with the first rotation shaft 21 as an axle of the gear device 2, as shown in FIGS. 2 and 3, and the housing 3 and the lid 4 are turned as well, such that the ornament 5 on the second rotation shaft 22 is turned along with the second rotation shaft 22. The ornament 5 rotates itself and moves around the housing 3, providing a dual turning effect.

In addition, because of the gear ratio of the gear device 2, the speed of revolution is less than the speed of rotation of the ornament 5. By the difference between the rotational speeds, the present invention provides a novel vision effect.

Although the present invention uses a conventional gear structure to achieve the purpose of rotation, its peripheral arrangement provides a different and novel vision effect of rotation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A rotating structure capable of revolution and rotation, comprising:
a base in a fixed state;
a gear device comprising a first rotation shaft and a second rotation shaft, the first rotation shaft being fixed to the base; and
an ornament coupled to the second rotation shaft.

2. The rotating structure capable of revolution and rotation as claimed in claim 1, wherein the base has a retaining trough for the first rotation shaft to be secured therein.

3. The rotating structure capable of revolution and rotation as claimed in claim 2, wherein the retaining trough is located at a central portion of the base.

4. The rotating structure capable of revolution and rotation as claimed in claim 1, wherein the first rotation shaft and the second rotation shaft are disposed on two opposite surfaces of the gear device.

5. The rotating structure capable of revolution and rotation as claimed in claim 1, wherein the first rotation shaft and the second rotation shaft of the gear device are not located at an identical axis of the gear device.

6. The rotating structure capable of revolution and rotation as claimed in claim 1, wherein the base is provided with a housing thereon, the housing is hollow to accommodate the gear device therein.

7. The rotating structure capable of revolution and rotation as claimed in claim 6, wherein the housing is covered with a lid.

8. The rotating structure capable of revolution and rotation as claimed in claim 7, wherein the lid has a through hole for the second rotation shaft to extend therefrom.

9. The rotating structure capable of revolution and rotation as claimed in claim 8, wherein the through hole is disposed close to an edge of the lid.

10. The rotating structure capable of revolution and rotation as claimed in claim 1, wherein the base is coupled to an attachment, the attachment being a writing article.
